(19) United States
(12) Patent Application Publication
(10) Pub. No.: US 2010/0154181 A1
(43) Pub. Date: Jun. 24, 2010

(54) Shape Memory Fastener

(75) Inventors: Cynthia M. Flanigan, Canton, MI (US); Patricia C. Tibbenham, West Bloomfield, MI (US); Jackie Rehkopf, Commerce Township, MI (US); David Dean, Commerce Township, MI (US)

Correspondence Address: Kristy J. Downing, Esq., 39555 Orchard Hill Pl., 6th Fl., PMB No.: 6051, Novl, MI, 48375, US

(73) Assignee: Ford Global Technologies LLC

(21) Appl. No.: 12/343,343

(22) Filed: Dec. 23, 2008

(51) Int. Cl. A44B 17/00; B29C 39/00

(52) U.S. Cl. 24/453; 264/299

(57) ABSTRACT

The present disclosure relates to a variety a releasable fasteners and fastening systems. Some fasteners include a shape memory polymer configured to change geometry of the fastener between a release geometry and an attachment geometry without application of a mechanical force.

### TECHNICAL FIELD

The present disclosure relates to fastening systems and sealers that utilize shape memory materials.

### BACKGROUND

Conventional automobiles include various components that can be attached using fastener mechanisms known within the art such as screws, nuts and bolts, spot welding, and mechanical rivets. Shape memory materials are a unique class of materials that can be grouped into three primary categories: metal alloys, polymers and gel networks. Shape memory materials can be programmed to return to a desired shape upon command. These materials have been dubbed “smart” or “intelligent” in nature due to the fact that they recover to their pre-programmed state after deformation. For example, thermal actuators are commonly utilized with shape memory alloys. While the generic response of these materials to an external stimulus such as temperature is relatively similar, the mechanism and conditions under which each of these categories of materials operates is distinctive. It is important to understand the differences between the metals and polymers when choosing these memory materials for certain applications.

One of the most commonly known classes of shape memory material is shape memory alloys (SMAs), which includes a nickel-titanium blend. This material has been utilized in a wide range of shape memory applications since the 1960's, including sensors, couplings, springs and consumer products. These metals are often used in applications requiring strength, stiffness and high temperature activation. While the opportunities for shape memory alloys seem endless, there are boundaries of use for SMAs. SMAs generally are expensive and have limited flexibility. For example, shape memory alloys may only be deformed with strains up to 8% to maintain their elastic-type behavior. The alloys exhibit a low temperature martensitic structure, with a plateau stress in its stress-strain relationship, which allows the material deformation to be recovered once the metal is heated to its austenite state (or bcc structure). This temperature transition is typically relatively high, e.g., around 500° C. Accordingly, the conditions under which SMAs can work effectively are limited by these constraints.

Shape memory polymers (SMPs) offer many advantages over their metal counterparts. In contrast to the SMAs, which can only withstand 8% strain, the polymers may be deformed up to 1000% and still recover their original shape. Furthermore, chemists may readily adjust the temperature at which the transition from the “original” shape to the “deformed” shape (or vice versa) occurs. The structure of the polymeric chains and functionality allow transition temperatures to be varied and controlled from −20° C. to over 150° C. The material's shape and modulus may be altered simply by changing the temperature of the polymer relative to its glass transition temperature. Such control over the activation point provides much more flexibility than the SMAs in designing automotive components for manufacturability.

Moreover, shape memory polymers also offer the advantage of being lightweight and an ability to be processed from a wide variety of methods such as thermoforming, injection molding and compression molding. Depending upon the polymer chosen, the shape memory polymer may also have a foam structure or may be optically transparent. Opportunities for use of these materials in the automotive industry are wide-ranging. The shape memory characteristics can be programmed into a wide range of polymer classes including polyurethanes, polycarbonate, ABS, nylon, vinyl, polyester and poly (methyl methacrylate). These materials account for the majority of polymer types used within current automobiles.

One of the challenges in designing a plastic part is to incorporate areas that may be readily accessed by the manufacturing assembler. In some modern fastening systems the assembler is required to utilize a specialized hand piece or gun that applies a mechanical force to the fastener to form it into the attachment shape. Such hand pieces can be difficult to maneuver in tighter spaces and they add to the overall costs of assembly.

Therefore, it is desirable to have a fastener system of lower costs that provides greater flexibility with increased ranges of deformation and greater control over the transition temperatures for the material. It is also desirable to have fasteners of lighter weight than existing SMAs. Moreover, it is desirable to have a fastening mechanism that has at least one accessible surface through which an assembler can control fastening.

### SUMMARY

In one exemplary embodiment, a releasable fastener includes a shaft having a shape memory polymer configured to change a geometry of the shaft between a release geometry and an attachment geometry without application of a mechanical force. The releasable fastener includes a first end accessible during fastening; and a second end having a plurality of arms at least partially composed of the shape memory polymer. The plurality of arms are positioned at an acute angle with respect to each other when the shaft is in the release geometry.

In another exemplary embodiment, a fastening system includes a fastener having a shape memory polymer configured to change a geometry of the fastener between a first geometry and an second geometry without application of a mechanical force. The fastener further comprises a first end accessible during fastening and a second end having a plurality of arms at least partially composed of the shape memory polymer. The system includes an actuator configured to actuate the shape memory polymer to change geometry. The plurality of arms are configured to fit through an orifice when the fastener is in the first geometry and the plurality of arms are configured not to fit through the orifice when the fastener is in the second geometry.

In another exemplary embodiment is a method of manufacturing a fastener at least partially composed of a shape memory polymer. The method includes: providing a shape memory polymer that can change a modulus of elasticity; and providing a mold to form the shape memory polymer. The mold defines a shaft having a plurality of arms at one end. The method also includes inserting the shape memory polymer into the mold; forming the shape memory polymer into an attachment geometry using an external stimulus; and removing the shape memory polymer from the mold. The mold is configured so that the plurality of arms are positioned at an angle greater than 45 degrees with respect to each other when the shape memory polymer is in the attachment geometry.

In another exemplary embodiment, a releasable fastener includes a shaft having an expandable shape memory polymer configured to change a geometry of the shaft between a release geometry and an attachment geometry without application of a mechanical force; a first end accessible during fastening; and a second end at least partially composed of the expandable shape memory polymer, configured to expand when the shaft is in the attachment geometry and shrink when the shaft is in the release geometry.

One advantage of the present invention is that the fastener exhibits a wide range of flexibility. In some embodiments the fastener can be programmed to deform as much as 1000% between a first and second geometry without losing its elastic behavior.

Another advantage of the present invention is that the fastener is made of a shape memory polymer whose transition temperature can be controlled over a wide range (e.g., −20° C. to 150° C.).

The present invention also includes at least one accessible surface during fastening so that assemblers can better control fastening. Advantageously, a fastening system includes a gun-less rivet that lowers costs and expands design options for components.

Another advantage of the present invention is that it employs shape memory foam to act as a sealer. The foam acts as a sealer and can be tightly packaged during assembly to fit through narrow holes or spaces.

The invention will be explained in greater detail below by way of example with reference to the figures, in which the same references numbers are used in the figures for identical or essentially identical elements. The above features and advantages and other features and advantages of the present invention are readily apparent from the following detailed description of the best modes for carrying out the invention when taken in connection with the accompanying drawings. In the figures:

### BRIEF DESCRIPTION OF THE DRAWINGS

FIGS. 1-4 illustrate a side view of a fastening system according to an exemplary embodiment of the present invention.

FIGS. 5-6 illustrate a side view of a fastener according to an exemplary embodiment.

FIGS. 7-8 illustrate cross-sectional views of a fastener according to an exemplary embodiment.

FIG. 9 illustrates a sleeve for use with a fastener according to an exemplary embodiment.

FIGS. 10-11 illustrate side views of a fastener that can be used with the sleeve of FIG. 9.

FIGS. 12-15 illustrate side views of a fastener according to an exemplary embodiment.

FIG. 16 illustrates a side view of a fastener according to an exemplary embodiment.

FIG. 17 illustrates a cross-sectional view of the fastener of FIG. 16.

FIG. 18 illustrates a cross-sectional view of a fastener and mating sleeve according to an exemplary embodiment.

FIG. 19 illustrates a side view of a fastener according to an exemplary embodiment.

FIG. 20 illustrates a cross-sectional view of the fastener of FIG. 19 with sleeve.

FIGS. 21-22 illustrate side views of a fastener according to an exemplary embodiment.

FIGS. 23-24 illustrate side views of a fastener according to another exemplary embodiment.

FIGS. 25-26 illustrate side views of a fastener according to another exemplary embodiment.

FIGS. 27-28 illustrate side views of a fastener according to another exemplary embodiment.

FIGS. 29-30 illustrate side views of a fastener according to another exemplary embodiment.

FIG. 31 illustrates a cross-sectional view of the fastener of FIGS. 29 and 30.

FIGS. 32-33 illustrate side views of a fastener according to another exemplary embodiment.

FIGS. 34-35 illustrate side views of a sealer according to another exemplary embodiment of the present invention.

FIG. 36 illustrates a side view of a vehicle door with door seal according to an exemplary embodiment of the present invention.

FIG. 37 illustrates a side view of the door seal of FIG. 36 at section 37.

FIG. 38 illustrates a side view of the door seal of FIG. 37 in an alternative geometry.

FIGS. 39-40 illustrate perspective cross-sectional view of an expandable door seal according to another exemplary embodiment.

FIG. 41 illustrates a mold assembly for a fastener according to an exemplary embodiment.

FIG. 42 illustrates a method of manufacturing a fastener at least partially composed of a shape memory polymer according to another exemplary embodiment of the present invention.

FIG. 43 is a graph showing the chemical processing cycle for shape memory foam according to an exemplary embodiment.

### DETAILED DESCRIPTION

Referring to the drawings, FIGS. 1-43, wherein like characters represent the same or corresponding parts throughout the several views there is shown a system for fastening components that utilizes shape memory materials. The fasteners disclosed herein relate to attaching plastic interior trim components for vehicle interiors. Other applications can include but are not limited to, for example, recreational devices, farming equipment, marine vehicles, children's toys, sporting equipment, furniture, electronic devices, or other transportation device.

With reference to FIG. 1, an exemplary embodiment of a fastening system 10 is shown. The fastening system 10 includes a fastener 20 that has a first and second end 30, 40 respectively. The first end 30 is accessible to an assembler during assembly. The first end 30 is open and not connected to other members. The shaft 50 of the fastener includes a shape memory polymer (or “SMP”). The SMP has been pre-programmed with a geometry that will enable the second end 40 to open and secure two or more components together. In the illustrated embodiment, the second end 40 includes a perforation 60 that separates the second end into a plurality of arms 70, 80 respectively. In the shown embodiment, two arms 70, 80 are included at the second end 40 of the fastener 20. The fastener 20 is in a release geometry as shown in FIG. 1. Arms 70, 80 are parallel to each other or 0° apart with respect to each other. In this arrangement the fastener 20 is relatively easy to insert in an orifice or sleeve as the arms 70, 80 and shaft 50 have a uniform profile. The fastener 20 can also be easily removed or popped out from an orifice or sleeve as the arms 70, 80 are inline with the shaft 50 of the fastener 20.

In another embodiment, the first end 30 is not open to the assembler. The fastener 20 can be actuated without directly contacting the first end 30 of the fastener. For example, the fastener 20 can be heated and return to an attachment geometry without having direct contact with the actuator. In this manner, the fastening system accommodates hard-to-reach places.

The fastening system 10 shown in FIG. 1 includes an actuator 90. In the illustrated embodiment, the actuator 90 is a thermal source. The actuator 90 sends a thermal signal (e.g., and increased temperature) to the fastener 20 to instruct the second end 40 of the fastener 20 to change its geometry from the release geometry to the attachment geometry and vice versa. The actuator 90 can be a heater or oven, for example, or any other device configured to transfer thermal energy to or from the fastener 20. The actuator 90 does not apply a mechanical force, such as pressure applied with a hammer or mallet, to form the fastener 20 in the attachment geometry or release geometry. In another embodiment the SMP is responsive to other stimuli, e.g., an electric signal or chemical signal. The SMP can be electrically stimulated when the SMP is composed of a conductive material. Exemplary conductive materials include any metallic materials, alloys, oxides, such as copper, chromium, tin, silver, nickel, iron titanium, steel, and magnesium.

In another embodiment the SMP is responsive to a chemical signal or stimulus. The actuator can be an optical or light stimulus. The SMP can be optically induced, composed of elastomers with light activated cross-linkers.

Also shown in FIG. 1, are a first and second component 100, 110 respectively. The first and second components 100, 110 include orifices (not shown) through which the fastener 20 can fit when the fastener is in the release geometry. The components 100, 110 represent vehicle interior components (e.g., pieces of an instrument panel, center mounted console, overhead console, or body frame). Components 100, 110 can be any mechanical fixture attached by conventional rivets or fasteners.

FIG. 2 shows the fastening system 10 of FIG. 1. The fastener 20 is in the release geometry and fit to be inserted in the orifices of the first and second component 100, 110. In the shown embodiment, the first end 30 of the fastener 20 does not pass through the components 100, 110. In this manner, the first end 30 remains accessible to an assembler during assembly. The second end 40 is fitted through the first and second component 100, 110. The second end includes a perforation 60 which at least partially extends beyond the first and second components 100, 110 when the fastener 20 is completely inserted into the first and second components, as shown in FIG. 2. The first and second arms 70, 80 are enabled to separate without restriction by the first and second component 100, 110 when the perforation extends beyond the distant surface 115 of the second component.

FIG. 3 shows the fastening system 10 of FIG. 1 with actuator 90 in activation mode. The actuator 90 sends a signal to the fastener 20 to instruct the fastener to change between the release geometry and the attachment geometry (as shown in FIG. 4). In the shown embodiment, the actuator 90 is a heat source that sends radiation waves to the fastener 20 to activate the fastener. The fastener 20 is heated to an activation temperature. In this embodiment the activation temperature for the fastener is 50° C. The second end 40 of the fastener 20 includes two arms 70, 80 that separate upon activation of the fastener. The arms 70, 80, as shown in FIG. 3, are separated at approximately a 90° angle with respect to each other. In this embodiment, the first and second components 100, 110 are forced together by the opening or separation of the arms 70, 80.

FIG. 4 shows the fastening system 10 of FIGS. 1-3. The fastener 20 is in the attachment geometry. Arms 70, 80 are approximately 1800 with respect to each other. The arms 70, 80 are extended perpendicularly with respect to the orifice in the first and second components 100, 110. In this manner the second end 40 of the fastener 20 is shaped so that it cannot fit through the orifice in the first and second components 100, 110 when the fastener is in the attachment position. The actuator 90 is turner off. The fastener can be restored to the release geometry (shown in FIG. 1) by the application of heat via the actuator 90. Actuator 90 is configured to heat the fastener 20 to a release temperature that is higher than the activation temperature to restore the fastener to the release geometry. In this embodiment, the release temperature is 120° C. Fastener 20 can be removed from the first and second component 100, 110 when restored into the release geometry. In another embodiment, the release temperature is lower than the activation temperature.

In the illustrated embodiment of FIGS. 1-4, the fastener 20 is configured to be in the release geometry at temperatures between 50° C. and 120° C. The fastener 20 is configured to be in the attachment geometry at 50° C. The SMP of the fastener 20 is a polyurethane and is configured to be programmed at 150° C. or higher. Activation temperature is adjustable to accommodate the materials being secured together, the application and manufacturing conditions. In some of the exemplary embodiments the SMPs are activated at a glass transition temperature (or “Tg”) of 25° C., 35° C., 45° C., 55° C., 65° C., 70° C., 90° C. and 120° C. At Tg the material modulus of elasticity decreases.

In another exemplary embodiment, another shape memory material is included with the fastener 20. The second shape memory material is configured to change the fastener geometry in an alternative manner. In another embodiment the second shape memory material is configured to alter its adhesive characteristics in response to an external stimulus.

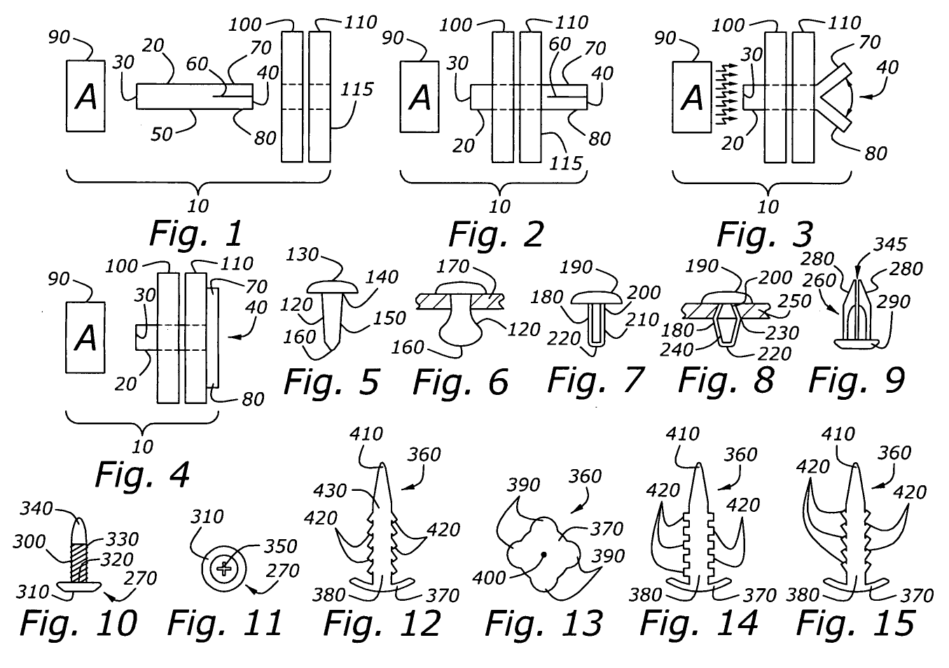

FIGS. 5 and 6 illustrate side views of a rivet 120 composed of a SMP according to another exemplary embodiment. The rivet includes a head 130 at a first end 140 and a shaft 150 that continues to the second end 160 of the rivet. The shaft 150 is of a fairly uniform in diameter when the rivet 120 is in the release geometry (as shown in FIG. 5). The second end 160 is tapered. Rivet 120 is configured to fit through an orifice in a component 170 when in the release geometry. When activated the rivet 120 forms into an attachment geometry as shown in FIG. 6. The second end 160 of the rivet expands radially when the fastener is in the attachment geometry. The expanded second end 160 cannot pass through the orifice in component 170. The rivet 120 shown in FIGS. 5-6 can be configured to actuate with any number of stimuli. In one embodiment, the rivet 120 actuates in response to a thermal signal or stimulus. In another embodiment, the rivet 120 actuates in response to an electrical signal or stimulus. In another embodiment, the rivet 120 actuates in response to a chemical signal or stimulus. In another embodiment, the rivet 120 actuates in response to an ultrasonic/light signal or stimulus. In another embodiment, the rivet 120 actuates in response to a mechanical force or stimulus.

FIGS. 7 and 8 illustrate a side view and a cross-sectional view (respectively) of a rivet 180 composed of a SMP according to another exemplary embodiment. The rivet 180 includes a head 190 at a first end 200 and a shaft 210 that continues to a second end 220 of the rivet. The shaft is of a fairly uniform in diameter when the rivet is in the release geometry (as shown in FIG. 7). Rivet 180 is configured to fit through an orifice 230 in a component when in the release geometry. When activated the rivet 180 forms into an attachment geometry as shown in FIG. 8. The shaft 210 of the rivet 180 is hollow. When activated a shell 240 of the shaft 210 expands radially. In the shown embodiment, the shaft 210 expands radially, proximate to the first end 200 of the rivet (or fastener) 180. In another embodiment, the shaft 210 expands at the second end 220 of the rivet 180. The expanded shaft cannot pass through the orifice 230 in component 250 when the rivet 180 is in the attachment geometry. The rivet 180 shown in FIGS. 7-8 can be configured to actuate with any number of stimuli. In one embodiment, the rivet 180 actuates in response to a thermal signal or stimulus. In another embodiment, the rivet 180 actuates in response to an electrical signal or stimulus. In another embodiment, the rivet 180 actuates in response to a chemical signal or stimulus. In another embodiment, the rivet 180 actuates in response to an ultrasonic/light signal or stimulus. In another embodiment, the rivet 180 actuates in response to a mechanical force or stimulus.

With reference to FIGS. 9-11, a fastening system is shown that includes a sleeve 260 and screw fastener 270. FIG. 9 is a side view of a sleeve 260 in which the fastener 270 can be inserted. The sleeve 260 includes a plurality of flanges 280 that can bend or flex with respect to the rim 290 of the sleeve. The sleeve 260 includes a series of threads (not shown) that are configured to mate with the threads 300 on the fastener 270. The sleeve 260 can be inserted into a larger mechanical component. The fastener 270 is inserted through an orifice in another component to attach the two components together.

FIG. 10 shows the side view of a screw 270 at least partially composed of a SMP according to another exemplary embodiment. Screw 270 includes a head 310 at a first end 320 and a shaft 330 that continues to the second end 340 of the rivet. The shaft 330 is of a fairly uniform diameter. The shaft 330 is tapered at the second end 340. The shaft 330 includes threads 300 that are configured to mate with threads in the sleeve. When the screw 270 is in the release geometry the threaded portion 300 of the shaft 330 is of less volume than when the screw is in an attachment geometry. The threaded portion 300 of the shaft 330 expands when the shaft is in the attachment geometry. In the shown embodiment the threaded portion 300 of the shaft is composed of a SMP. In another embodiment, the threaded portion 300 of the shaft is covered with a SMP that selectively expands upon command. The expanded shaft 330 cannot pass through the orifice 345 in the sleeve 260 when the screw is in the attachment geometry. The SMP reduces in volume when the screw 270 is in the release geometry.

FIG. 11 illustrates the head 310 of the screw 270. The head 310 includes a crest 350 in which a screw driver can fit. The screw 270 can be mechanically turned into the sleeve 260. The head 310 is also configured to receive a signal from an actuator to activate the SMP. The screw 270 shown in FIGS. 10-11 can be configured to actuate with any number of stimuli. In one embodiment, the screw 270 actuates in response to a thermal signal or stimulus. In another embodiment, the screw 270 actuates in response to an electrical signal or stimulus. In another embodiment, the screw 270 actuates in response to a chemical signal or stimulus. In another embodiment, the screw 270 actuates in response to an ultrasonic/light signal or stimulus. In another embodiment, the screw 270 actuates in response to a mechanical force or stimulus.

FIGS. 12-15 show a fastener 360 according to another exemplary embodiment. FIG. 12 is a side view of the fastener 360 configured in the shape of what is commonly referred to as a “push” or “Christmas tree” fastener. Fastener 360 includes a crowned head 370 (as further illustrated in FIG. 13) at a first end 380 of the fastener. The head 370 includes a plurality of discs 390. In the shown embodiment, the head 370 includes a dimple 400. In another embodiment, the head 370 includes a crest that can be utilized with a screwdriver. Fastener 360 is tapered at a second end 410 of the fastener. Fastener 360 further includes a plurality of arms (or combs) 420 that extend from a shaft 430 of the fastener. The arms 420 are at least partially composed of a SMP (e.g., a nylon composite). Arms 420 can open to various angular positions with respect to the shaft 430. In FIG. 12, arms 420 are shown positioned at an acute angle (approximately 45°) with respect to the first end 380 of the shaft 430 of fastener 360. In this illustration the fastener 360 is in a release geometry. Fastener 360 is configured to fit through an orifice in a component when in the release geometry. When activated the fastener 360 forms into an attachment geometry as shown in FIGS. 14 and 15. Arms 420 are positioned perpendicularly with respect to the shaft 430 of fastener 360 in FIG. 14. FIG. 14 illustrates a first attachment geometry of the fastener 360. The fastener 360 can be formed into a second attachment geometry. In the second attachment geometry arms 360 are angled at an obtuse angle with respect to the first end 380 of the shaft 430 (as shown in FIG. 15). In the shown embodiment, the arms 420 are configured at approximately a 135° angle with respect to the first end 380 of the shaft 430. When the fastener 360 is in either the first or second attachment geometry it cannot be fit through the orifice in a component.

Fastener 360 is designed to have a minimum retention of 15 kg and maximum insertion force of 5 kg when pushed or inserted into a 6.0 inch diameter hole in a steel panel that has a thickness of 2.5 inches. In one embodiment, the fastener 360 includes a perforation at the second end. The fastener 360 shown in FIGS. 12-15 can be configured to actuate with any number of stimuli. In one embodiment, the fastener 360 actuates in response to a thermal signal or stimulus. In another embodiment, the fastener 360 actuates in response to an electrical signal or stimulus. In another embodiment, the fastener 360 actuates in response to a chemical signal or stimulus. In another embodiment, the fastener 360 actuates in response to an ultrasonic/light signal or stimulus. In another embodiment, the fastener 360 actuates in response to a mechanical force or stimulus.

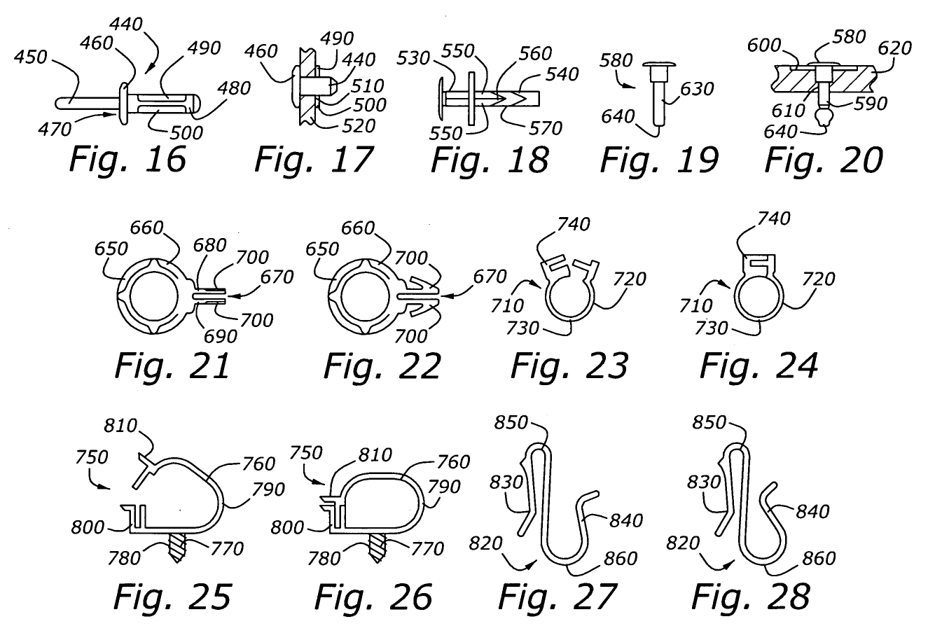

Referring now to FIGS. 16-17 a side and cross-sectional view (respectively) is shown of a rivet 440 at least partially composed of a SMP according to an exemplary embodiment. The rivet 440 is commonly referred to as a “blind truss head” rivet. The rivet 440 includes a pin 450 and rim 460 that is positioned along a center section 470 of the pin. The second half of the rivet includes a collapsible frame 480. The frame 480 includes a first and second member 490, 500 respectively that can change position with respect to a component. In the release geometry the first and second member 490, 500 are at angle of 0° with respect to each other. Rivet 440 is configured to fit through an orifice 510 in a component 520 when in the release geometry. The pin 450 is fairly uniform in diameter when the rivet is in the release geometry (as shown in FIG. 16). In the attachment geometry, as shown in FIG. 17, the first and second members 490, 500 are positioned at an angle of 90° with respect to the component 520. The collapsed members 490, 500 cannot pass through the orifice 510 in the component 520 when the rivet 440 is in the attachment geometry. In the shown embodiment, the pin 450 detaches from the rivet 440 when the rivet is in the attachment geometry. The pin 450 is used to assist in guiding the rivet 440 through the component 520. In another embodiment, the rivet 440 does not include the pin. Rivet 440 is guided into an orifice of the component manually and the shape is changed using an external stimulus. In the illustrated embodiment, the rivet 440 is composed of a nylon composite. The mandrel breaking load of the rivet 440 is between 400 and 500 Newtons. Shear strength of the rivet 440 is approximately 850 Nm. The rivet 440 shown in FIGS. 16-17 can be configured to actuate with any number of stimuli. In one embodiment, the rivet 440 actuates in response to a thermal signal or stimulus. In another embodiment, the rivet 440 actuates in response to an electrical signal or stimulus. In another embodiment, the rivet 440 actuates in response to a chemical signal or stimulus. In another embodiment, the rivet 440 actuates in response to an ultrasonic/light signal or stimulus. In another embodiment, the rivet 440 actuates in response to a mechanical force or stimulus.

With reference to FIG. 18, a cross-section of a rivet 530 and sleeve 540 according to an exemplary embodiment is shown. Rivet 530 is configured to be inserted in sleeve 540 when the rivet is in a release geometry as shown in FIG. 18. Rivet 530 includes a plurality of flanges 550 that can bend or flex with respect to the sleeve 540. The sleeve 540 can be inserted into a larger mechanical component. The rivet 530 is inserted through an orifice in another component to attach the two components together. Rivet 530 is at least partially composed of a SMP. Flanges 550 are of a fairly uniform in profile when rivet 530 is in the release geometry. Flanges 550 are tapered at the second end 560. The second end 560 of the rivet 530 includes a SMP. The second end 560 of the rivet 530 is configured to expand when in an attachment geometry. Flanges 550 that separate when the SMP is activated. The expanded flanges 550 cannot pass through an orifice 570 in the sleeve 540 when the rivet 530 is in the attachment geometry. The rivet 530, shown in FIG. 18, can be configured to actuate with any number of stimuli. In one embodiment, the rivet 530 actuates in response to a thermal signal or stimulus. In another embodiment, the rivet 530 actuates in response to an electrical signal or stimulus. In another embodiment, the rivet 530 actuates in response to a chemical signal or stimulus. In another embodiment, the rivet 530 actuates in response to an ultrasonic/light signal or stimulus. In another embodiment, the rivet 530 actuates in response to a mechanical force or stimulus.

FIGS. 19-20, illustrate a side and cross-sectional view (respectively) of a rivet 580 and sleeve 590 according to another exemplary embodiment. Rivet 580 is configured to be inserted in sleeve 590 when the rivet is in a release geometry as shown in FIG. 19. The sleeve 590 can be inserted into a larger mechanical component 600, as shown in FIG. 20. The rivet 580 is inserted through an orifice 610 in another component 620 to attach components 600 and 620 together. Rivet 580 is at least partially composed of a SMP. Rivet 580 includes a shaft 630 that is fairly uniform in diameter when the rivet is in the release geometry. The second end 640 of the rivet 580 is configured to expand when in an attachment geometry. The second end 640 is configured to balloon to a diameter larger than the diameter of the sleeve 590 when the rivet 580 is in the attachment geometry. The rivet 580 shown in FIG. 18 can be configured to actuate with any number of stimuli. In one embodiment, the rivet 580 actuates in response to a thermal signal or stimulus. In another embodiment, the rivet 580 actuates in response to an electrical signal or stimulus. In another embodiment, the rivet 580 actuates in response to a chemical signal or stimulus. In another embodiment, the rivet 580 actuates in response to an ultrasonic/light signal or stimulus. In another embodiment, the rivet 580 actuates in response to a mechanical force or stimulus.

FIGS. 21-22 illustrate a fastener 650 at least partially composed of a SMP according to another exemplary embodiment. Fastener 650 includes a ring 660 through which different mechanical fixtures (such as tubing) can be fit. Fastener 650 can also serve as an electrical wire harness. Fastener 650 includes a distal end 670 composed of a SMP. Distal end 670 includes two arms 680, 690 with expandable sections 700. Each section 700 is configured to extend at an angle with respect to the arms 680, 690. In FIG. 21, the fastener 650 is in a release geometry. In the shown embodiment of FIG. 21, sections 700 are positioned at an angle of 45° with respect to the arms 680, 690. In the attachment geometry, shown in FIG. 21, fastener 650 cannot be removed from an orifice in a component. Fastener 650 shown in FIGS. 21-22 can be configured to actuate with any number of stimuli. In one embodiment, the fastener 650 actuates in response to a thermal signal or stimulus. In another embodiment, the fastener 650 actuates in response to an electrical signal or stimulus. In another embodiment, the fastener 650 actuates in response to a chemical signal or stimulus. In another embodiment, the fastener 650 actuates in response to an ultrasonic/light signal or stimulus. In another embodiment, the fastener 650 actuates in response to a mechanical force or stimulus.

FIGS. 23-24 illustrate a fastener 710 at least partially composed of a SMP according to another exemplary embodiment. Fastener 710 includes a ring 720 through which different mechanical fixtures (such as tubing or electrical wiring) can be fit. Ring 720 of fastener 710 selectively opens and closes between a release and attachment geometry, respectively. FIG. 23 shows a release geometry. The bow 730 of ring includes a SMP configured to reduce the stiffness in the bow when not activated. When activated fastener 710 is in an attachment geometry. The SMP has an increased stiffness when activated. At each end of the ring is a clasp 740. Clasp 740 interconnects the two ends of ring when the fastener 710 is in the attachment geometry. Fastener 710 shown in FIGS. 23-24 can be configured to actuate with any number of stimuli. In one embodiment, the fastener 710 actuates in response to a thermal signal or stimulus. In another embodiment, the fastener 710 actuates in response to an electrical signal or stimulus. In another embodiment, the fastener 710 actuates in response to a chemical signal or stimulus. In another embodiment, the fastener 710 actuates in response to an ultrasonic/light signal or stimulus. In another embodiment, the fastener 710 actuates in response to a mechanical force or stimulus.

In another embodiment, a fastener 750 is at least partially composed of a SMP as shown in FIGS. 25-26. Fastener 750 includes a ring 760 through which different mechanical fixtures (such as tubing or electrical wiring) can be fit. At one end of ring is a screw fastener 770 or screw that can be attached to another fixture. In the shown embodiment, the screw 770 is not composed of a SMP. In an alternative embodiment, the screw includes a SMP, the shaft 780 of screw expands upon activation. In another embodiment, the threads of screw 770 are sprayed with a SMP to expand upon activation when the fastener is in the attachment geometry. With reference to FIGS. 25 and 26, ring 760 of fastener selectively opens and closes between a release and attachment geometry, respectively. FIG. 25 shows a release geometry. The bow 790 of ring includes a SMP configured to reduce the stiffness in the bow when not activated. When activated fastener is in an attachment geometry (as shown in FIG. 26). The SMP has an increased stiffness when activated. At each end of the ring is a clasp 800. Clasp interconnects the two ends of ring when the fastener is in the attachment geometry. Fastener also includes a handle 810 at the end of clasp. Fastener 750 shown in FIGS. 25-26 can be configured to actuate with any number of stimuli. In one embodiment, the fastener 750 actuates in response to a thermal signal or stimulus. In another embodiment, the fastener 750 actuates in response to an electrical signal or stimulus. In another embodiment, the fastener 750 actuates in response to a chemical signal or stimulus. In another embodiment, the fastener 750 actuates in response to an ultrasonic/light signal or stimulus. In another embodiment, the fastener 750 actuates in response to a mechanical force or stimulus.

FIGS. 27-28 illustrate a fastener 820 at least partially composed of a SMP according to another exemplary embodiment. Fastener 820 includes a first and second clamp 830, 840 respectively. First clamp 830 can be attached to a fixture. Second clamp 840 has a larger radius of curvature than first clamp 830. Fixtures such as tubing or electrical wiring can be fit in the bow 850 of clamp 830. Fastener 820 selectively opens and closes between a release and attachment geometry, respectively. FIG. 27 shows a release geometry. A bow 860 of clamp 840 includes a SMP configured to reduce the stiffness in the bow when not activated. When activated fastener 820 is in an attachment geometry (as shown in FIG. 28). The SMP has an increased stiffness when activated. In another embodiment, the bow 850 in clamp 830 includes a SMP. Clamp 830 can be activated to change between a release and attachment geometry. SMP in clamp 830 is configured to reduce the stiffness in bow 850 when it is not activated and increase in stiffness when activated. Fastener 820 shown in FIGS. 27-28 can be configured to actuate with any number of stimuli. In one embodiment, the fastener 820 actuates in response to a thermal signal or stimulus. In another embodiment, the fastener 820 actuates in response to an electrical signal or stimulus. In another embodiment, the fastener 820 actuates in response to a chemical signal or stimulus. In another embodiment, the fastener 820 actuates in response to an ultrasonic/light signal or stimulus. In another embodiment, the fastener 820 actuates in response to a mechanical force or stimulus.

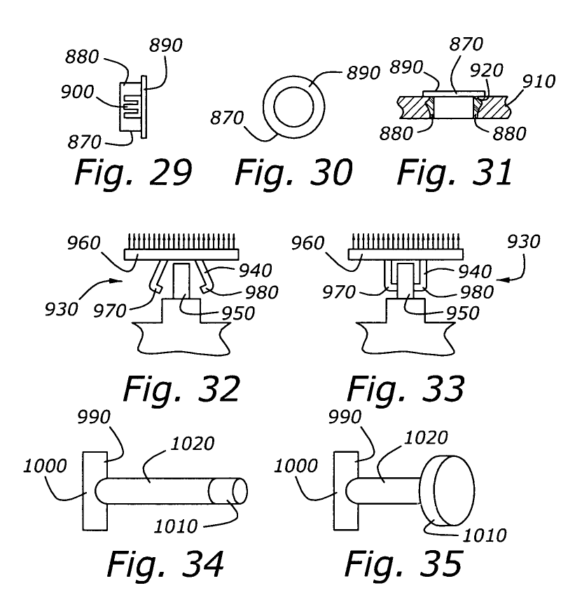

With reference to FIGS. 29-31, a bushing 870 at least partially composed of a SMP is shown. Bushing 870 includes a sleeve 880 and rim 890. Rim 890 (shown in FIG. 30) includes a flanged edge. As shown in FIG. 29, sleeve 880 includes a series of perforations 900. Perforations 900 can reduce the weight and material part cost of busing. Perforations 900 can also reduce the overall stiffness of sleeve 880 to ease in the insertion and removal of bushing 870 during assembly. When inserted into a component 910 the sleeve 880 of bushing fits into the mechanical fixture as shown in FIG. 31. Sleeve 880 includes a SMP. Upon activation the walls of the sleeve 880 are configured to expand radially, securing busing 870 in component 910 at an attachment geometry. When deactivated the walls of sleeve 880 reduces in volume and bushing 870 is able to fit through an orifice 920 in component 910. Bushing 870 shown in FIGS. 29-31 can be configured to actuate with any number of stimuli. In one embodiment, the bushing 870 actuates in response to a thermal signal or stimulus. In another embodiment, the bushing 870 actuates in response to an electrical signal or stimulus. In another embodiment, the bushing 870 actuates in response to a chemical signal or stimulus. In another embodiment, the bushing 870 actuates in response to an ultrasonic/light signal or stimulus. In another embodiment, the bushing 870 actuates in response to a mechanical force or stimulus.

Referring now to FIGS. 32-33, a fastener 930 at least partially composed of a SMP according to another exemplary embodiment. Fastener 930 includes a clamp 940. Clamp 940 can be attached to fixture 950. Clamp 940 is connected to a board 960 such as a circuit board, filter, or other platform. Clamp 940 includes a first and second arm 970, 980. Arms 970, 980 selectively open and close between a release and attachment geometry, respectively. FIG. 32 shows arms 970, 980 in a release geometry. Arms 970, 980 include a SMP configured to reduce the stiffness at the hinge of each arm when not activated. When activated fastener 930 is in an attachment geometry (as shown in FIG. 33). The SMP has an increased stiffness when activated. Fastener 930 shown in FIGS. 32-33 can be configured to actuate with any number of stimuli. In one embodiment, the fastener 930 actuates in response to a thermal signal or stimulus. In another embodiment, the fastener 930 actuates in response to an electrical signal or stimulus. In another embodiment, the fastener 930 actuates in response to a chemical signal or stimulus. In another embodiment, the fastener 930 actuates in response to an ultrasonic/light signal or stimulus. In another embodiment, the fastener 930 actuates in response to a mechanical force or stimulus.

Other fasteners can include the SMP outside of the illustrated exemplary embodiments. Other types of fasteners include, but are not limited to, T-shaped fasteners, button or mushroom cap fasteners, and rose buds fasteners.

While the illustrated embodiments are at least partially composed of a SMP, in alternative embodiments fasteners can be composed of other shape memory materials (e.g., shape memory alloys). One benefit of the SMP, depending on the geometry of the SMP, is that it can obtain 800% to 1000% deformation while having the elasticity to return to its predetermined shape. While the deflection of an SMA depends on its geometry as well, the typical deflection for a SMA for a temperature increase of 10° C. can be 1-2 mm. With SMPs a deflection for a temperature increase of 10° C. can be as great as 15 mm providing far greater deformation at a given temperature. Other material properties can be selectively altered as a function of temperature. In one embodiment the SMP alters the damping characteristics of the material with a change in temperature. In another embodiment, the SMP alters the gas/moisture permeability of the material with a change in temperature. This material having applicability in fasteners as well as sealers (e.g., vehicle door seals). The refractive index or dielectric constant of the material can change with an increase in temperature as well. In another embodiment, the material is programmed with an attachment geometry according to a change in the refractive index of the material. The advantages of this response include the fact that the temperature can be adjusted to accommodate the materials being secured together and could be tailored for the manufacturing conditions. For example, the polymer could change geometries while the component is sent through an oven during the manufacturing process. In this manner, fastener serves as a “gun-less rivet.”

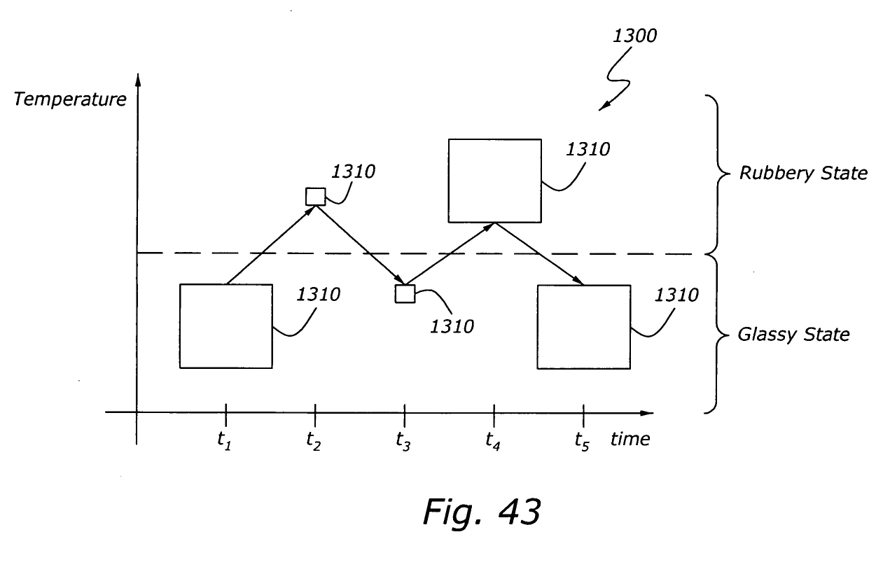

Some fasteners include the use of this material with a foam cylinder that can expand after being heated. FIGS. 34 and 35 illustrate a sealer 990 according to an exemplary embodiment. Sealer 990 includes a first end having a head 1000. At the second end of the sealer is a disc 1010 composed of a SMP. In the release geometry, as shown in FIG. 34, the disc 1010 has a similar diameter to a shaft 1020 of the sealer 990. The disc 1010 can be attached to shaft 1020 using an adhesive. In the attachment geometry, as shown in FIG. 35, the disc 1010 is configured to expand upon activation. When inserted into a component the disc 1010 fits into the mechanical fixture. Sealer 990 shown in FIGS. 34-35 can be configured to actuate with any number of stimuli. In one embodiment, the sealer 990 actuates in response to a thermal signal or stimulus. In another embodiment, the sealer 990 actuates in response to an electrical signal or stimulus. In another embodiment, the sealer 990 actuates in response to a chemical signal or stimulus. In another embodiment, the sealer 990 actuates in response to an ultrasonic/light signal or stimulus. In another embodiment, the sealer 990 actuates in response to a mechanical force or stimulus. Foam expansion characteristics are further discussed with respect to FIG. 43.

In one embodiment, SMPs are used to improve vehicle door seals. Wind noise in the vehicle cabin can be a significant concern for vehicle passengers. While many factors such as vehicle architectural structure, part tolerances, and body frame matching play a significant role in controlling wind noise, door seals play a primary role in reducing wind noise in the vehicle cabin. Door seals function to eliminate any spacing or gaps between the vehicle door and body frame, reduce the other outside noise, such as squeaks and rattles, and to eliminate water leakage inside the vehicle cabin. Smaller door seals increase the risk of water leakage and outside noise while larger door seals make the door more difficult to close. The illustrated embodiment offers the advantage of allowing the door seal to reduce unwanted outside noise while easing the door's ability to close. The use of a SMP in the seal enables the geometry of the seal to be changed upon pre-programmed conditions. The geometry of the SMPs can be changed with or without user input. For example, when the door is closed and the engine is started the door seal can be expanded to have a larger diameter. When the vehicle engine is off, the door seal can have a reduced diameter, easing the door's ability to be opened and closed. In this manner, the SMPs can increase customer satisfaction by reducing common customer concerns, such as wind noise and door closing efforts.

The material can be activated using any number of external stimuli. In one embodiment, the actuator provides an electronic signal to the door seal to control the door seal geometry. The actuator draws power from the vehicle battery or other power source. As the car engine is turned on the actuator sends a first electronic signal to enlarge the door seal. When the engine is turned off the actuator sends a second electronic signal to reduce the size of the door seal. The actuator can be any know processor or switch. In another embodiment, the actuator includes a heater and the SMP can be activated thermally. Other external stimuli include, ultrasonic waves, electric field, mechanical force, or chemical reaction that enable the SMP return to its predetermined shape.

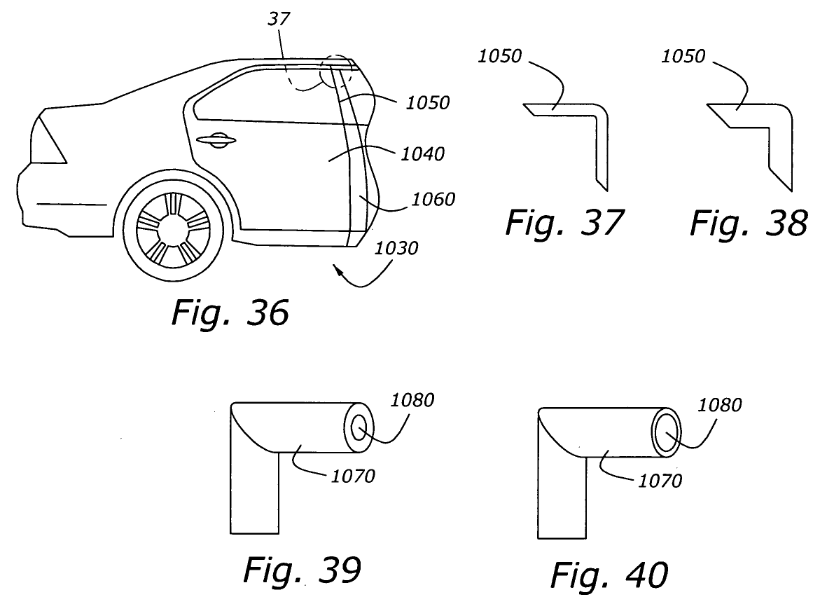

FIG. 36 illustrates a partial side view of a vehicle 1030 having a vehicle door 1040 with door seal 1050 around the perimeter of the door. While the illustrated embodiment shows a rear passenger door, the seal 1050 can be used with various vehicle components such as, for example, other doors, trunk and cargo storage, and interior vehicle compartments.

With reference to FIG. 37, which illustrates the door seal 1050 of FIG. 36. The SMP is shown in a contracted (or “thin”) geometry. The SMP contracts in anticipation of the door 1040 closing and opening. When the door 1040 is closed the SMP can expand into an expanded geometry, e.g. having a larger outer diameter in the expanded geometry than in the contracted geometry. FIG. 38 illustrates the door seal 1050 of FIG. 37 with the SMP in the expanded geometry. As a occupant (such as the driver) closes the door 1040, a stimulus will be triggered. As shown in FIG. 38 the seal 1050 expands against the vehicle body structure 1060 and door 1040. After the stimulus is released the seal 1050 returns to a predetermined geometry prior to the door 1040 being re-opened, as shown in FIG. 37. The process of the SMP changing between the contracted and expanded geometry can be repeated indefinitely.

In the illustrated embodiment of FIGS. 39-40, a hollow tube 1070 includes a SMP. The tube 1070 is composed of rubber. When activated, the SMP 1080 in the tube 1070 will cause the tube to expand. In this arrangement, the expanded geometry is in the pre-programmed shape. FIG. 39 illustrates a perspective cross-sectional view of the tube 1070 and SMP 1080. The SMP 1080 is inserted in the tube 1070 so that the SMP is concentric with the tube 1070. The SMP is configured to expand when activated with a stimulus. Such expansion causes the outer diameter of the rubber tube 1070 to increase in size and fill the gaps between the door and vehicle body frame. In an alternative embodiment the tube 1070 can be completely composed of the SMP. The tube 1070 or door seal can be programmed with an expanded geometry similar to the embodiment illustrated in FIG. 40.

Expansion of door seals can be accomplished via a number of user inputs. In one embodiment, the driver can activate the SMP in the door seal by shifting the vehicle from park to drive mode. In this embodiment, shifting the vehicle from drive to park sends a signal to the SMP instructing the SMP to collapse to the starting geometry. In another embodiment, the SMP can be activated by the engine or vehicle exceeding a predetermined speed. In another embodiment, the SMP can be activated by turning the vehicle engine on. In the shown embodiment, the SMP is composed of a water-resistant material.

In another embodiment, a two-way SMP is utilized as a sealer. The two-way SMP alters its geometry in more than one dimension. For example, the shaft can change its length as well as its diameter. In another embodiment, the sealer is composed of two different materials, each having shape memory characteristics.

Other applications include, but are not limited to, windshield adhesives, tubes, safety belts, steering wheels, grip ridges, hook-and-loop fasteners, springs, gaskets for disassembly, packaging/dunnage, seat removal and lock system to facilitate easy release/locking of seats, and alignment tools.

In one embodiment a SMP is used as a windshield wiper adhesive. The SMP is sprayed onto the wiper arm. The adhesion characteristics of the adhesive change upon activation. The blade attaches to the wiper arm upon activation of the SMP. The adhesive used in this embodiment can be utilized for other applications (e.g., interior vehicle components, trim elements, lighting lenses and casing). The adhesive can also be configured to actuate with any number of stimuli including but not limited to a thermal signal, electrical signal, ultrasonic signal, light signal or chemical signal.

In another embodiment a SMP is used as a selectively expanding tube. The SMP is formed into a cylindrical shape. In the deactivated geometry the tube has a smaller diameter than the diameter of the tube in the activated geometry. In this way, the tube can be inserted into or removed from smaller orifices during assembly. In another embodiment, the tube is a two-way deforming SMP. The tube can be programmed to bend or deform along the axis of the tube upon activation. In this arrangement the tube bends at a 45° radius of curvature when in the activated geometry and has a 0° radius of curvature when in the deactivated geometry. The SMP can be configured to actuate with any number of stimuli including but not limited to a thermal signal, electrical signal, chemical signal, ultrasonic signal, light signal or mechanical force.

In another embodiment a SMP is used with a conventional seat belt or steering wheel. The seat belt is wrapped with the SMP. The SMP is configured to expand upon activation. The SMP can be a shape memory foam. Activation of the SMP is linked with crash sensory technology. When a control unit senses vehicle crash conditions the SMP on the seat belt expands. In normal driving conditions the SMP is contracted. The SMP can be sprayed onto existing vehicle components or interwoven with existing components (for example). The SMP can also be configured to actuate with any number of stimuli including but not limited to a thermal signal, electrical signal, chemical signal, ultrasonic signal, light signal or mechanical force.

In another embodiment a steering wheel includes the shape memory material. The material is programmed to deploy during vehicle crash. “OOP conditions” meet maxilla impact criteria. Likewise structural components of the vehicle body can be spray coated with a SMP to increase the dampening effect of the component during vehicle crash. The expanded SMP (e.g., a foam) absorbs the energy of an impact. In one arrangement, the A-pillar, B-pillar and C-pillar are sprayed with a SMP. The SMP is configured to deploy when a crash is sensed. Crash sensors are connected with an actuator that sends the deployment signal to the SMP. The SMP can be thermally or electrically actuated, for example. A plurality of actuators can be placed throughout the vehicle. The actuators can include thermal sources.

In one embodiment a SMP is used in other attachment systems. For example, in one embodiment the SMP is included in a hook-and-loop fastener system. A SMP is applied to one surface. The SMP can change its abrasive characteristics upon actuation. A plurality of arms selectively extend from one surface when the SMP is actuated. When the SMP is inactive the arms lay substantially flat with respect to the surface. A complementary surface includes a textured fabric that can be attached to the plurality of arms when the SMP is activated. In another embodiment, grip ridges on a handle or other surface are composed of a SMP. The ridges of the gripper change in geometry upon activation of the SMP. The grip can have a textured surface when the SMP is activated and a smooth surface with respect to the handle when the SMP is inactive. The SMP can also be configured to actuate with any number of stimuli including but not limited to a thermal signal, electrical signal, chemical signal, ultrasonic signal, light signal or mechanical force.

In one embodiment a spring is composed of a SMP. The spring can be any type of spring known within the art. The spring constant changes upon activation of the SMP. In one embodiment the spring is a coil spring while in another embodiment the spring is a leaf spring. Springs can be used in the disassembly of various vehicle components or to assist in lifting components, e.g., a vehicle hood. In one embodiment a gasket spring composed of a SMP is utilized to move one element with respect to another element. In another embodiment, active sealing fasteners with washers are configured to pop out when the SMP is heated. The SMP can also be configured to actuate with any number of stimuli including but not limited to a thermal signal, electrical signal, chemical signal, ultrasonic signal, light signal or mechanical force.

In one embodiment a SMP is used in the composition of packaging components, such as for example casing or dunnage. The geometry of the packaging can change upon activation. The packaging can be stored and shipped in a more compact geometry. In one embodiment, a packaging unit for shipping fragile equipment includes a wall at least partially spray coated with a SMP (e.g., a shape memory foam). After filled with cargo the SMP expands to secure the cargo. To remove cargo, SMP is deactivated. The SMP can also be configured to actuate with any number of stimuli including but not limited to a thermal signal, electrical signal chemical signal, ultrasonic signal, light signal or mechanical force.

In one embodiment a number of assembly tools are composed of a SMP. A seat removal and lock system is composed of a SMP to facilitate easy release/locking of the seats. The locking system can include a number of fasteners that alternate between an attachment and release geometry upon activation. Such fasteners can solve some material fitting in assembly squeak and rattle issues. The size of the fastener can adjust to accommodate various components. In this manner, the SMP can supplement gaps in components due to failure to meet design tolerances. In one embodiment, a shape memory foam is used that has material surface changes to accommodate a wide range of spacing geometries. In another embodiment, an alignment tool is composed of a SMP. The SMP can also be configured to actuate with any number of stimuli including but not limited to a thermal signal, electrical signal chemical signal, ultrasonic signal, light signal or mechanical force.

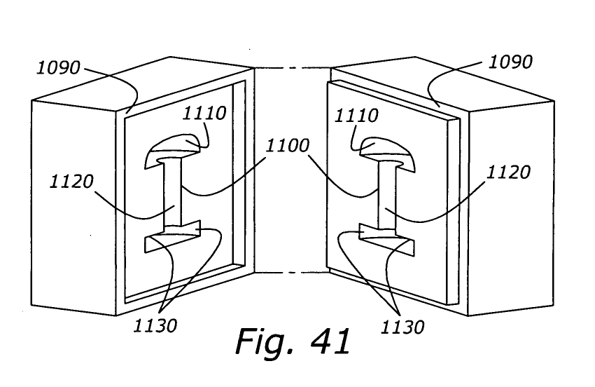

Fasteners such as rivets can be manufactured using a mold 1090 or die as shown in FIG. 41. Mold 1090 includes a profile 1100 of the rivet in its attachment geometry. The fastener is molded into the attachment geometry in this embodiment. The mold 1090 includes the head 1110, shaft 1120 and extended arms 1130 of the fastener. A SMP is heated to a first temperature that enables the SMP to be programmed into a first geometry. The first geometry of the rivet molded by mold 1090 is an attachment geometry (e.g., as shown in FIG. 4). The SMP can be injected into mold 1090 at a temperature of 150° C. or higher. As the SMP cools, a rivet is formed into the attachment geometry. The SMP can be heated to second temperature that is less than the first temperature. The second temperature sends a thermal signal to the SMP to form into a second (or release) geometry. The rivet can be inserted into an orifice to attach a number of components at this temperature. When the assembler is ready to attach said components assembler sends another thermal signal to the SMP (at a third temperature) to instruct the SMP to return to the attachment geometry.

The mold 1090 shown in the exemplary embodiment of FIG. 41 is blank. In this embodiment, the rivet can be entirely composed of a SMP. In another embodiment, the mold 1090 is filled with additional structural members, e.g., a metallic head to enable the fastener to be screwed into place or configured to receive an electrical signal. In this arrangement, the fastener is partially composed of a SMP. Mold 1090 can include a plurality of cavities to manufacture multiple fasteners of similar or different shapes simultaneously. Mold 1090 can be composed of a vinyl compound or other materials suitable for manufacturing conditions of the fastener.

The devices disclosed herein can be molded using any number of known methods, e.g., injection molding, compression molding, or thermoforming. The SMP comes in a pellet or microbeads that can be formed into the programmed geometry via, e.g., injection molding or extrusion. In another embodiment, the SMP comes in the form of a resin, fabric or hardener; the material is molded using a potting process. In another embodiment the SMP is provided as a solution and is molded using a traditional casting process. The solution can act as a coating to fixtures and attachment members. Two liquids can be utilized for casting (e.g., a primary and curing agent).

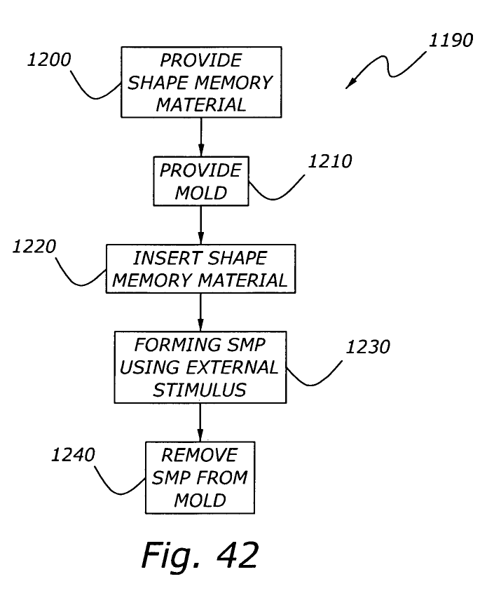

A method 1190 of manufacturing a fastener at least partially composed of a SMP is also included with the present disclosure as shown in FIG. 42. The method includes: providing a shape memory polymer that can change a modulus of elasticity 1200; and providing a mold to form the shape memory polymer 1210. The mold defines a shaft having a plurality of arms at one end. The method also includes inserting the shape memory polymer into the mold 1220; forming the shape memory polymer into an attachment geometry using an external stimulus 1230; and removing the shape memory polymer from the mold 1240. The mold is configured so that the plurality of arms are positioned at an angle greater than 45 degrees with respect to each other when the shape memory polymer is in the attachment geometry.

In another embodiment, the method further includes forming the shape memory polymer into a release geometry using the external stimulus. The mold is configured so that the plurality of arms are positioned at an acute angle with respect to each other when the shape memory polymer is in the release geometry.

FIG. 43 illustrates another method 1300 of programming a SMP according to an exemplary embodiment. The graph shown in FIG. 43 shows the geometry of a SMP 1310 as a function of time and temperature. The y-axis shows the temperature in which the SMP is heated. The x-axis shows time from t₁ to t₅. At t₁ the SMP 1310 is at an expanded geometry, the temperature of the SMP is such that the SMP is in a glassy state. The SMP 1310 is heated at t₂. The SMP contracts to a smaller geometry. The SMP is in a rubbery state. The SMP 1310 is enabled to cool at this state (as shown at t₃) and return to a glassy state. When the SMP 1310 is re-heated it transitions from the glassy state to a rubbery state (as shown at t₅). When the SMP 1310 transitions to the rubbery state it expands to the geometry the SMP formed at t₄. The SMP maintains this geometry even as it is cooled (as shown at t₅).

The SMP can be composed of any polymers known within the art. Polymers can be used to manufacture, for example, hard plastics, rubbers and foams. Other acceptable materials also include, for example, PMMA, ABS, PU, PC, nylon, PVC, vinyl, and polyester acetyl. Various polyurethane compounds can be programmed to provide the desired characteristics of the SMPs discussed herein. One embodiment utilizes polyurethane SMP that consist of 98% polyurethane resin and 2% additives. The polyurethane comprises Diphenylmethane-4,4′-diisocyanate, adipic acid, ethylene glycol, ethylene oxide, polypropylene oxide, 1,4-buteanediol, and bisphenol A.

Any polymer or polymer blend known within the art can be utilized with the present teachings and still be within the spirit of the present invention. Thermoplastics and interpenetrating networks are used in one embodiment. Exemplary polymers include, but are not limited to, polyurethanes, polyalkylene oxides, polyethers, polyphosphazenes, poly(vinyl alcohols), polyamides, polyester amides, poly(amino acid)s, polyanhydrides, polycarbonates, polyacrylates, polyalkylenes, polyacrylamides, polyvinyl ethers, polyalkylene glycols, polyalkylene terephthalates, polyortho esters, polyvinyl esters, polyvinyl halides, polyesters, polylactides, polyglycolides, polysiloxanes, polyurethanes, polyether amides, polyether esters, copolymers, polyacrylates, polystyrene, polypropylene, polyvinyl phenol, polyethylene, polyvinylpyrrolidone, chlorinated polybutylene, poly(octadecyl vinyl ether), ethylene vinyl acetate, poly(ethylene oxide)-poly(ethylene terephthalate), polyethylene/nylon, polycaprolactones-polyamide, poly(caprolactone) dimethacrylate-n-butyl acrylate, urethane/butadiene copolymers, poly(norbornyl-polyhedral oligomeric silsequioxane), polyvinylchloride, polyurethane block copolymers, and styrene-butadiene-styrene block copolymers.

The invention has been described with reference to certain aspects. These aspects and features illustrated in the drawings can be employed alone or in combination. E.g., SMPs can be utilized as active disassembly using smart materials (or “ADSMs”). Modifications and alterations will occur to others upon a reading and understanding of this specification. Although the described aspects discuss a polymer as one material of construction, it is understood that other materials can be used for selected components if so desired. It is understood that mere reversal of components that achieve substantially the same function and result are contemplated, e.g., providing a fastener composed of a shape memory material can be accomplished via various configurations without departing from the present invention. It is intended to include all such modifications and alterations insofar as they come within the scope of the appended claims or the equivalents thereof. While several examples for carrying out the invention have been described, those familiar with the art to which this invention relates will recognize alternative designs and embodiments for practicing the invention. Thus, the above-described embodiments are intended to be illustrative of the invention, which may be modified within the scope of the following claims. Moreover, while the best modes for carrying out the invention have been described in detail, those familiar with the art to which this invention relates will recognize various alternative designs and embodiments for practicing the invention within the scope of the appended claims.

We claim:

1. A releasable fastener, comprising:
a shaft including:
a shape memory polymer configured to change a geometry of the shaft between a release geometry and an attachment geometry without application of a mechanical force;
a first end accessible during fastening; and
a second end having a plurality of arms at least partially composed of the shape memory polymer, the plurality of arms positioned at an acute angle with respect to each other when the shaft is in the release geometry.

2. The fastener of claim 1, wherein the fastener is a rivet having a head at the first end.

3. The fastener of claim 1, further comprising a shape memory material configured to change at least one of a geometry and adhesive characteristics in response to an external stimulus.

4. The fastener of claim 1, wherein the shape memory polymer is configured to change the geometry of the shaft in response to a thermal signal.

5. The fastener of claim 4, wherein the shape memory polymer is configured to achieve the release geometry at a first temperature and the attachment geometry at a second temperature, the second temperature is greater than the first temperature.

6. The fastener of claim 1, wherein the shape memory polymer is configured to change the geometry of the shaft in response to an electrical signal.

7. The fastener of claim 1, wherein the shape memory polymer is configured to change the geometry of the shaft in response to a chemical signal.

8. The fastener of claim 1, wherein the plurality of arms are positioned at an angle less than 45 degrees with respect to each other in the release geometry.

9. The fastener of claim 8, wherein the plurality of arms are positioned at an angle less than 5 degrees with respect to each other in the release geometry.

10. The fastener of claim 1, wherein the plurality of arms are positioned at an angle greater than 45 degrees with respect to each other in the attachment geometry.

11. The fastener of claim 10, wherein the plurality of arms are positioned at an angle greater than 90 degrees with respect to each other in the attachment geometry.

12. The fastener of claim 1, wherein the shape memory polymer is configured to change a modulus of elasticity of the shaft.

13. A fastening system, comprising:
a fastener including a shape memory polymer configured to change a geometry of the fastener between a first geometry and an second geometry without application of a mechanical force; wherein the fastener further comprises a first end accessible during fastening and a second end having a plurality of arms at least partially composed of the shape memory polymer;
an actuator configured to actuate the shape memory polymer to change geometry;
wherein the plurality of arms are configured to fit through an orifice when the fastener is in the first geometry; and
wherein the plurality of arms are configured not to fit through the orifice when the fastener is in the second geometry.

14. The system of claim 13, wherein the fastener is a rivet including a head at the first end.

15. The fastener of claim 13, further comprising a shape memory material configured to change at least one of a geometry and adhesive characteristics in response to an external stimulus.

16. The system of claim 13, wherein the actuator is heater and the shape memory polymer is configured to change the geometry of the shaft in response to a thermal signal.

17. The system of claim 16, wherein the shape memory polymer is configured to achieve the first geometry at a first temperature and the second geometry at a second temperature, the second temperature is greater than the first temperature.

18. The system of claim 13, wherein the shape memory polymer is configured to change the geometry of the shaft in response to an electrical signal.

19. The system of claim 13, wherein the shape memory polymer is configured to change the geometry of the shaft in response to a chemical signal.

20. The system of claim 13, wherein the plurality of arms are positioned at an angle less than 45 degrees with respect to each other in the first geometry.

21. The system of claim 20, wherein the plurality of arms are positioned at an angle less than 5 degrees with respect to each other in the first geometry.

22. The system of claim 13, wherein the plurality of arms are positioned at an angle greater than 45 degrees with respect to each other in the second geometry.

23. The system of claim 22, wherein the plurality of arms are positioned at an angle greater than 90 degrees with respect to each other in the second geometry.

24. The system of claim 13, wherein the shape memory polymer is configured to change a modulus of elasticity.

25. A method of manufacturing a fastener at least partially composed of a shape memory polymer, comprising:
providing a shape memory polymer that can change a modulus of elasticity;
providing a mold to form the shape memory polymer, wherein the mold defines a shaft having a plurality of arms at one end;
inserting the shape memory polymer into the mold;
forming the shape memory polymer into an attachment geometry using an external stimulus; and
removing the shape memory polymer from the mold;
wherein the mold is configured so that the plurality of arms are positioned at an angle greater than 45 degrees with respect to each other when the shape memory polymer is in the attachment geometry.

26. The method of claim 25, further comprising:
forming the shape memory polymer into a release geometry using the external stimulus;
wherein the mold is configured so that the plurality of arms are positioned at an acute angle with respect to each other when the shape memory polymer is in the release geometry.

27. A releasable fastener, comprising:
a shaft including:
an expandable shape memory polymer configured to change a geometry of the shaft between a release geometry and an attachment geometry without application of a mechanical force;
a first end accessible during fastening; and
a second end at least partially composed of the expandable shape memory polymer, configured to expand when the shaft is in the attachment geometry and shrink when the shaft is in the release geometry.

28. The fastener of claim 27, wherein the fastener is a sealer.

29. The fastener of claim 27, further comprising a shape memory material configured to change at least one of a geometry and adhesive characteristics in response to an external stimulus.

30. The fastener of claim 27, wherein the expandable shape memory polymer is configured to change the geometry of the shaft in response to a thermal signal.

31. The fastener of claim 30, wherein the expandable shape memory polymer is configured to achieve the release geometry at a first temperature and the attachment geometry at a second temperature, the second temperature is greater than the first temperature.

32. The fastener of claim 27, wherein the expandable shape memory polymer is configured to change the geometry of the shaft in response to an electrical signal.

33. The fastener of claim 27, wherein the expandable shape memory polymer is configured to change the geometry of the shaft in response to a chemical signal.

34. The fastener of claim 27, wherein the expandable shape memory polymer is a foam.

35. The fastener of claim 27, wherein the expandable shape memory polymer is a rubber.
